(19) United States
(12) Patent Application Publication
(10) Pub. No.: US 2019/0050600 A1
(43) Pub. Date: Feb. 14, 2019

(54) MASKING DISPLAY OF SENSITIVE INFORMATION

(71) Applicant: CA, Inc., Islandia, NY (US)

(72) Inventors: Tapan Sahoo, Bangalore (IN); Badrinath Mohan, Bangalore (IN)

(21) Appl. No.: 15/675,114

(22) Filed: Aug. 11, 2017

(51) Int. Cl. G06F 21/62; G06F 21/31; G06F 3/0481

(52) U.S. Cl. CPC G06F 21/6281; G06F 2221/032; G06F 3/0481; G06F 21/31

(57) ABSTRACT

An attempt by a particular program on a computing device to present a particular message on the computing device is detected. Prior to presentation of the particular message on the graphical display, the contents of the particular message are scanned to determined that at least a portion of the content of the particular message includes sensitive information. The content of the particular message is modified to generate a masked version of the particular message, where the masked version masks the portion of the content. The masked version of the particular message is allowed to be presented on the graphical display based on determining that the particular message includes the sensitive information.

### BACKGROUND

The present disclosure relates in general to the field of computer systems, and more specifically, to providing security of messages for presentation on user computing devices.

With the sale, production, and deployment of mobile phones and other handheld and mobile computing devices eclipsing more traditional desktop personal computing devices, consumers and users have come to expect increased mobility in their access to computer applications, the Internet, digital communications, and other software services and resources. This increased demand has contributed to a corresponding acceleration in developments and advancements within mobile computing devices. Mobile computing devices can connect to multiple different networks using a variety of protocols. Mobile computing devices exist that are adapted to connect to WiFi networks, wireless broadband networks (such as 3G, 4G, LTE, and other cellular networks), as well as short range networks such as Bluetooth piconets. Peripheral devices have been developed for mobile computing devices such as smartphones and other mobile phones, such as Bluetooth hands-free headset devices, allowing a user to send and receive voice data to their mobile phone using the headset device. New security concerns are emerging from the paradigm shift introduced through the development and widespread of mobile user computing devices.

### BRIEF SUMMARY

According to one aspect of the present disclosure, an attempt by a particular program on a computing device to present a particular message on the computing device may be detected. Prior to presentation of the particular message on the graphical display, the contents of the particular message may be scanned to determined that at least a portion of the content of the particular message includes sensitive information. The content of the particular message may be modified to generate a masked version of the particular message, where the masked version masks the portion of the content. The masked version of the particular message may be allowed to be presented on the graphical display based on determining that the particular message includes the sensitive information.

### BRIEF DESCRIPTION OF THE DRAWINGS

FIG. 1 illustrates a simplified schematic diagram of an example computing environment including an example user computing device.

FIG. 2 illustrates a simplified block diagram of an example software system including a user computing device with an example message manager.

FIG. 3 illustrates a simplified block diagram representing masking of sensitive data intended for display on a user computing device.

FIG. 4 illustrates a flowchart illustrating the handling of messages for display on a user computing device.

FIGS. 5A-5E are screenshots of a display of a user computing device illustrating the example masking of sensitive data intended for display on the user computing device.

FIGS. 6A-6C are screenshots of a display of a user computing device.

FIG. 7 is a flowchart illustrating the example techniques relating to masking of sensitive data intended for display on a user computing device.

Like reference numbers and designations in the various drawings indicate like elements.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

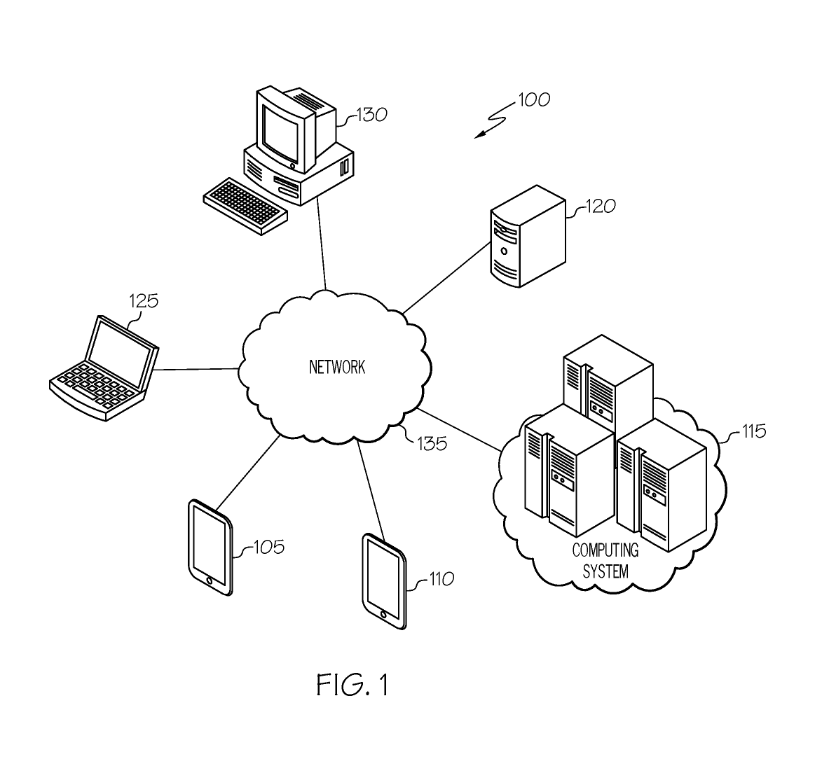

FIG. 1 illustrates a simplified schematic diagram of an example computing environment 100. In some embodiments, computing environment 100 may include functionality to enable the detection and masking of sensitive data, which may be otherwise displayed on a user computing device (e.g., 105, 110, 125, 130, etc.) including when the computing device is in a locked or sleep state. For instance, programs on the user computing device (e.g., 105, 110, 125, 130, etc.) may present certain messages on the display of the device to grab the attention of the user. An operating of the computing device may allow some of these programs to present messages to the user even when the computing device is locked or in a sleep mode as a convenience to the user to allow the user to be presented within interesting and important messages as they arrive (e.g., from external systems (e.g., 115)) or are generated at the user computing device using these programs. Such notifications (referred to herein as “notification messages” may be provided to make the user aware of their information in real time, rather than later, when the user next logs in to the device, when the information may have become stale, expired, or become irrelevant.

While notification messages may be a convenient and desirable way to communicate information to a user, particularly on mobile computing devices (e.g., smart phones, wearables, onboard vehicle computers, etc.) that may be carried or used consistently throughout the day by a user. Given the constant presence of the device, a user may be theoretically reached through a notification message at any point during the day. Further, notification messages may be used to communicate sensitive information to a user, as the personal nature of some mobile devices may serve as a proxy for the user themselves. However, the “always on” nature of notification messages may, at the same time, present a security vulnerability. For instance, notification messages, among their other uses, have become popular channels through which sensitive information is communicated, such as one-time passwords, bank account or electronic payment information, sensitive personal messages, among other information. As notification messages may be presented on a display screen of a user computing device even when the user computing device is in a locked or sleep mode, user authentication is not required for a user (including unauthorized or even malicious users) to view the notification and its contents. Accordingly, improved user computing devices (e.g., 105, 110, 125, 130, etc.) may be provided with message management logic to allow the display of notification messages while hiding sensitive information included in the notification message. For instance, an example message manager may detect sensitive information included in a notification message that is being prepared for display on the computing device (e.g., by one or more programs or even the operating system on the device (e.g., 105, 110, 125, 130, etc.) and mask at least a portion of this sensitive information when the message when the message is displayed on the user computing device (e.g., 105, 110, 125, 130, etc.). Authorization of the user may then be mandated as a prerequisite for unmasking or displaying the masked portion of the notification message in the clear.

An example system 100 may additionally include one or more other systems, which may interface with an improved user computing device (e.g., 105, 110, 125, 130) equipped with a message manager to protect against the inadvertent presentation of sensitive information in notification messages, which may be displayed on the device. In one example, notification messages, or at least a portion of the information to be included in a notification message, may be generated by an external computing system (e.g., 115) and communicated over one or more communication networks 135. In one example, the computing system 115 may be a backend application server system, which is utilized by a client application installed on a device (e.g., 105) to receive or pull information usable by the client application. The client application, in some instances, may act to generate a notification message from the information received from the backend service and may act (e.g., through a call to the device's operating system) to request that the generated notification message be displayed on the device. In another example, the external computing system 115 may be a system supporting short message service (SMS) messaging, device-to-device messaging, instant messaging, or another messaging platform, which may occasionally push messages to the computing device (e.g., 105, 110, 125, 130, etc.) over one or more networks (e.g., 135). Such messaging platforms (even general-purpose messaging platforms) may be periodically used to send messages, including messages that contain sensitive information. An example message manager implemented on an improved computing device (e.g., 105, 110, 125, 130, etc.) may be equipped with functionality to detect sensitive information included in any one of potentially many different message formats or messages generated from in connection with multiple different programs (or backend systems (e.g., 115)) run on the computing device, among other examples.

In another example, external computing systems (e.g., 120) may additionally be provided, which possess functionality to support, or assist the operation, of an example message manager implemented on an example user computing device (e.g., 105, 110, 125, 130, etc.). For instance, a message manager may utilize detection logic or policies which are hosted, updated, or otherwise provided, at least in part, by a backend service (e.g., hosted on system 120). For instance, determining which information is sensitive or not may be based on one or more policies, which may be fine-tuned to a particular user or entity exercising control over the user device or which may be based on user feedback, machine learning, or other techniques. For instance, a message management support service may be hosted on an external system (e.g., 120) and may interface with and collect data from multiple instances of message managers implemented on multiple different user devices (e.g., 105, 110, 125, 130, etc.) to aggregate feedback received from these various devices to improve policies and algorithms used to detect sensitive information corresponding to these policies. In one example, message managers may utilize algorithms or detection models to identify sensitive information in notification messages which are to be presented on a user computing device. Such models may be based on heuristic analyses, machine learning algorithms, or other techniques. While detection models may, in some implementations, be developed locally on a user computing device that is to host the message manager using the detection model, in other cases, detection models may be built and updated (e.g., in some cases continuously from feedback data received from potentially multiple different client devices (e.g., 105, 110, 125, 130, etc.)) by an external system 120, which a user computing device (e.g., 105, 110, 125, 130, etc.) may communicate over a network (e.g., 135) to obtain the generated models. In still other examples, a message manager may communicate with a service provided by an external system (e.g., 120) and query the service to identify whether and what portions of a proposed notification message include sensitive information. The service may then provide (through a communication over one or more networks 135) an indication of the sensitive information (if any) present in the message, which the message manager may then use to augment the notification message to mask the sensitive information, among other examples. In some implementations, an external system (e.g., the same system or a system associated with the system (e.g., 120) that is to support instances of a message manager) may provide the message manager for download onto a user computing device (e.g., 105, 110, 125, 130, etc.), such as to add message management functionality to the device. In other instances, the message manager utility may be provided natively on the device, such as implemented in the operating system of the device, implemented (at least in part) in an instruction set architecture (ISA) of the device, implemented in hardware circuitry of the device, as offered in a standard set of applications or tool, among other example implementations.

In general, elements of computing environment 100, such as “systems,” “servers,” “services,” “hosts,” “devices,” “clients,” “networks,” “mainframes,” “computers,” and any components thereof (e.g., 105, 110, 115, 120, 125, 130, etc.), may include electronic computing devices operable to receive, transmit, process, store, or manage data and information associated with computing environment 100. As used in this disclosure, the term “computer,” “processor,” “processor device,” or “processing device” is intended to encompass any suitable processing device. For example, elements shown as single devices within computing environment 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Further, elements of computing environment 100 (e.g., 105, 110, 115, 120, 125, 130, etc.) may each include one or more processors, computer-readable memory, and one or more interfaces, among other features and hardware. Servers may include any suitable software component or module, or computing device(s) capable of hosting and/or serving software applications and services, including distributed, enterprise, or cloud-based software applications, data, and services. For instance, in some implementations, a data provenance system 105, artifact generation tool (e.g., 110), indexed artifact server 115, and/or other sub-systems or components of computing environment 100, may be at least partially (or wholly) cloud-implemented, “fog”-implemented, web-based, or distributed for remotely hosting, serving, or otherwise managing data, software services, and applications that interface, coordinate with, depend on, or are used by other components of computing environment 100. In some instances, elements of computing environment 100 may be implemented as some combination of components hosted on a common computing system, server, server pool, or cloud computing environment, and that share computing resources, including shared memory, processors, and interfaces. Indeed, a variety of networks and network technologies may be used in various implementations to interconnect components and subsystems described herein. For instance, networks 135 used to communicatively couple the components of computing environment 100, may include, for example, local area networks, wide area networks, public networks, the Internet, cellular networks, Wi-Fi networks, short-range networks (e.g., Bluetooth or ZigBee), and/or any other wired or wireless communication medium.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

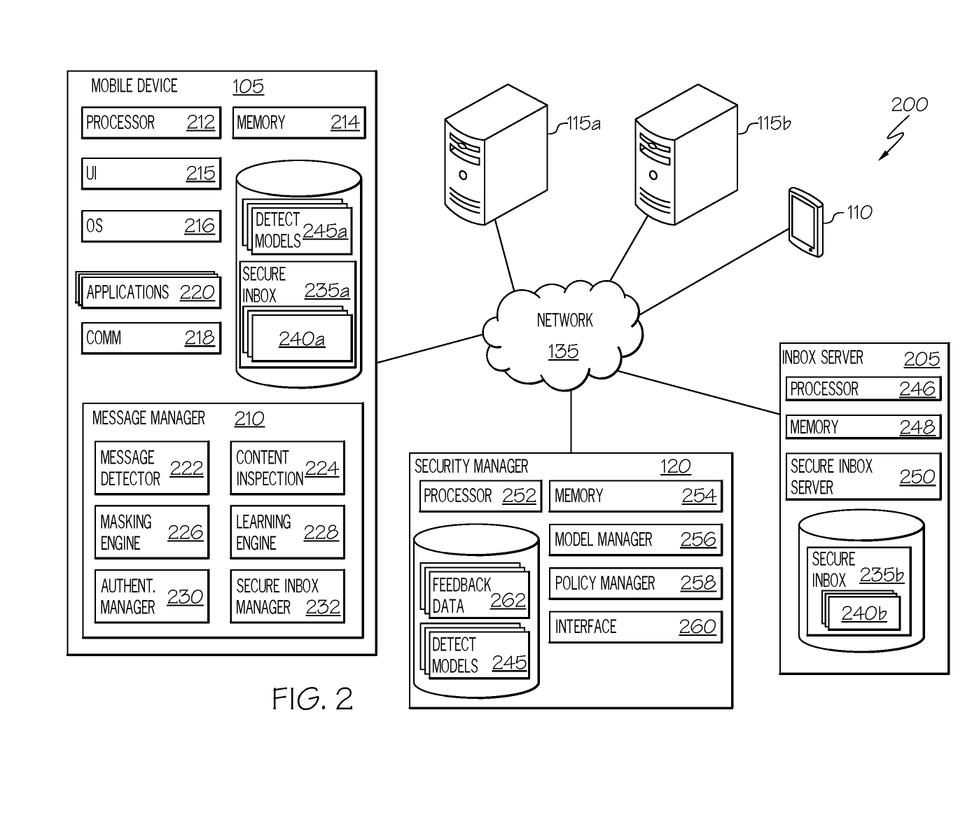

Turning to FIG. 2, a simplified block diagram 200 is illustrated of an example system including user computing devices (e.g., 105, 110) including respective instances of an example message manager 210 to address issues and implement functionality such as introduced above. For instance, a user computing device may be a mobile computing device, such as a smart phone, wearable computer, portable gaming console, portable multimedia device, Internet of Things (IoT) device, or other device. The device 105 may include one or more data processing apparatus 212, one or more computer-readable memory elements 214, and other components (e.g., 210, 216, 218, 220, etc.) implemented in hardware and/or machine-executable code stored in the memory elements 214 and executable by the one or more data processing apparatus 212. The device 105 may additionally include one or more presentation devices 215, such as a graphical display device, whereon graphical user interfaces may be displayed including graphical notification messages. In some implementations, the presentation device 215 may include an audio presentation module and speakers to present messages audibly instead of or in addition to graphical presentations, among other examples. An operating system 216 may be provided on the device 105 to orchestrate functionality of the device and provide an interface between software and hardware of the device. In some implementations, the operating system 216 may be used to cause notifications and other information to be presented on presentation devices 215 provided on the device 105. Further, a communication module 218 may be provided to enable the device 215 (and its respective programs (e.g., operating system 216, applications 220, message manager 210, etc.)) to communicate with one or more other systems (e.g., 115a,b, 120, 210, etc.) over one or more networks (e.g., 135). Various applications 220 may be hosted on the device 105, some of which may generate notification messages for presentation (e.g., graphically and/or audibly) on presentation devices 215 provided on the device 105.

An example message manager 210 may include various functional components implemented in software, firmware, and/or hardware of the computing device 105. For instance, a message detector 222 may be provided to detect that a notification message is being or has been prepared for presentation on the device 105 (e.g., using presentation devices 215). In some implementations, the message detector 222 may intercept a call (e.g., to the operating system 216 or the processor 212 itself) that corresponds to a request to present a notification message on the device 105, among other example implementations. In some implementations, interception of such a call (or otherwise detecting and acting on a proposed notification message) may be predicated on the device 105 (or its operating system 216) being in a locked, sleep, or other state in which the notification message could be potentially presented without the authentication of the current user (e.g., a person or monitor which may potentially see or hear the presentation of the notification message). Accordingly, in some implementations, an authentication manager 230 may be provided, which may detect the current authentication status of the device and allow this status to be considered by the message manager 210 in determining how to handle a detected, proposed notification message.

Upon detection of a proposed notification message, a content inspection module 224 of the message manager 210 may inspect content of the proposed notification to detect whether the proposed notification message includes sensitive content. Indeed, the content inspection module 224 may identify those specific words, images, or values representing sensitive information. In some implementations, a content inspection module 224 may make use of one or more detection models 245a. In some instances, the detection model may be obtained from an external computing system (e.g., 120). In other instances, one or more detection models may be defined by a user (e.g., through the message manager). In still other instances, one or more detection models may be provided with the message manager 210 (e.g., during its installation), among other examples, and combinations of the foregoing.

Upon identifying sensitive information in the content of a notification message using the content inspection module 224, a masking engine 226 may augment the notification message to cause the identified sensitive information to be masked from presentation. For instance, information to be displayed as text with the notification message may be replaced with generic characters to mask the sensitive text. For sensitive image data, the masking engine 226 may cause all or a portion of the image representing the sensitive information to be blurred or blacked out, etc. to mask the sensitive image. In the case of an audio presentation, words corresponding to the identified sensitive information may be omitted, bleeped, obscured, or otherwise altered such that the presentation of the sensitive audio content is masked, among other examples.

In some implementations, a learning engine 228 may be provided, which may identify user feedback to identify where the message manager 210 was over- or under-inclusive in identifying sensitive information in notification messages. For instance, a user may identify an instance where sensitive information was missed by the content inspection module 224 (e.g., based on a detection model 245a) and the learning engine 228 may modify the detection model 245 based on the feedback locally on the device 105. In other cases, this feedback information may be sent or shared (e.g., by a learning engine 228) with an external system (e.g., 120), which is responsible for managing detection models and the external system (e.g., using model manager 256) may consider the 8 (e.g., along with potentially other related feedback from other users) to determine whether the model should be modified to better address the feedback. In another example, a user may identify that some information was incorrectly masked and provide feedback to indicate that non-sensitive information was incorrectly masked. In some cases, a learning engine 228 may modify a corresponding local detection model (e.g., 245a) such that, in the future, this information is presented unmasked and in the clear. Such feedback and findings may likewise be shared with a supporting service (e.g., hosted by an external system (e.g., 120)) such that a global version of the detection model may also consider the feedback and improve detection models relied upon by instances of the message manager 210 on the device 105 and other devices (e.g., 110), among other examples.

As introduced above, in some implementations, an external security management system (e.g., 120) may be provided, which may interface with instances of a message manager 210 to support and improve the functioning of instance of an example message manager 210 on respective host devices (e.g., 105, 110). In one implementation, an example support system 120 may include one or more data processing apparatus 252, one or more computer-readable memory elements 254, and other components (e.g., 256, 258, 260, etc.) implemented in hardware and/or machine-executable code stored in the memory elements 254 and executable by the one or more data processing apparatus 252. For instance, a model manager 256 may be provided to implement functionality for maintaining, developing, updating, and providing one or more detection models 245 for use by message managers 210 provided on various computing devices (e.g., 105). The detection models may define or support algorithms, which may be executed at the message managers 210 to assist the message managers 210 in identifying which portions, if any, of the content of notification messages incorporate sensitive information. In some implementations, the detection models be heuristic models, machine learning models, rule definitions, or other models, which may be used to determine which content set to be presented in a notification message is likely sensitive information or not. Further, a model manager 256 may finetune the detection models 245 to account for false positives or false negatives (e.g., as observed and reported by a user of a device (e.g., 105) equipped with a message manager 210 using the detection model. Such feedback may be received as feedback data 262, which may be consumed by the model manager 256 to implement modifications to one or more corresponding detection models 245, among other examples.

In some implementations, an example security manager system 120 may provide one or more of potentially multiple different detection models to host devices (e.g., 105) for use by their respective message managers. In such instances, to determine which detection models 245 to provide to a given message manager instance (e.g., 210), policy manager logic 258 may be provided to determine that one or more security policies or preferences are to apply to at a corresponding device (e.g., 105). For instance, it can be determined that the device 105 is associated with a particular entity (e.g., a business, governmental agency, educational institution, etc.), for which security policies have been defined to govern the use of various devices owned, provided, or otherwise managed in accordance with the particular entity. In other cases, one or more policies may be defined that are determined to be associated with the device 105 based on the make or model of the device, its operating system, the applications installed on the device, the network to which the device is connected, or other characteristics of the device, some of which may change over time, resulting in the corresponding policies also being adjusted. All such characteristics may be considered by a policy manager in determining the one or more policies to apply at the device. Further, user-defined policies and preferences may be defined and communicated to the security management system 120 (e.g., by the respective device or by another computer associated with the device's user) to customize the message management at the device. In some implementations, a policy manager 258 may consider the characteristics, preferences, and policies of a device and its user(s) in order to determine which detection models 265 to provide for the device's message manager. In other implementations, preference and policy management may be performed, at least in part on the device itself, to allow a user to specify the types of notifications and content to manage and potentially mask at the device. Such local preference and/or policy management may cause the message manager 210 to customize its use of supporting detection models, as well as cause the message manager 210 to request (e.g., through interface 260, such as an application programming interface (API)) updated models to assist the message manager 210 in providing the levels of protection corresponding to the specified user inputs, among other example implementations.

When a message manager 210 identifies sensitive information in a proposed notification message (e.g., using content inspection module 224), the message manager 210 may identify (e.g., using authentication manager 230) whether the device 2105 is in a locked, sleep, or other unauthenticated state and mask the presentation of the sensitive information (e.g., using masking engine 226), such that only unmasked portions of the notification message are presented while the device is in an unauthenticated state (i.e., when authorized users have yet to reauthenticate to the device). A masked version of a notification message may provide a notice to the user that a message containing sensitive information has arrived without allowing the message to be presented in the clear around unauthorized users. An authorized user may then gain access to the full, unmasked content of the notification message by authenticating to the device 105 (which may be detected by authentication manager 230). In some implementations, unmasked versions 240a) of masked messages may be managed by a secure inbox manager 232 to cause the unmasked notification messages to be stored in a secure inbox 235a on the device. Access to the secure inbox 235a and the unmasked messages 240a stored therein, may be predicated on the user successfully authenticating to the device 105 (e.g., by providing a password, personal identification number (PIN), biometric information, or other authentication data). The user may then determine whether the messages should be deleted, saved, or otherwise dealt with. In some implementations, a secure inbox (e.g., 235b) may additionally or alternatively provided in an external system (e.g., inbox server 205), such as a cloud-based system. For instance, in one example, an inbox server system 205 may include one or more data processing apparatus 246, one or more memory elements 248 (e.g., storing machine executable code for execution by the processor 246), and implement a secure inbox server 250 to provide secure inboxes (e.g., 235b) for various users of devices (e.g., 105) equipped with a message manager 210. In some instances, rather than storing unmasked versions of notification messages locally on the device 105, the message manager 210 may cause the unmasked versions (e.g., 240b) to be securely communicated (e.g., over an encrypted channel) for storage in a secure inbox 235b hosted on a remote system (e.g., 205). A user may likewise authenticate to the device 105 and/or the inbox server 205 in response to identifying a masked version of the message to thereby allow the user to access the unmasked version (e.g., 240b) of the message. While in some instances, masking of a notification message may result in presentation of a partially masked message, which may notify a user that a notification message containing sensitive information has been received (and prompting the user to login to access an unmasked version of the message(s) 240a,b stored securely (e.g., in an encrypted form) in a corresponding secure inbox 240a,b), in other instances a message manager, rather than presenting a masked version, may instead or additionally provide a separate notification notifying the user that a protected version of the message has been stored in a secure inbox (e.g., 235a,b) rather than being presented on the device 105. In some implementations, the message manager 210 may identify certain types of particularly sensitive notification messages and elect to hide the entirety of the message and lock the message in a secure inbox (e.g., 235a,b) rather than present a masked version of the message (as it may do in other cases (e.g., based on one or more policies or preferences governing operation of the message manager 210)). As an example, if a threshold duration of time is detected to have expired since the last successful login by an authorized user, the message manager may presume that there is a lower likelihood that the device (e.g., 105) is still in the possession of the user and may completely hide the arrival of a message containing sensitive information by immediately storing the notification message in a secure inbox (e.g., 235a,b). On the other hand, if the message is detected within a threshold amount of time from the last successful login, a masked version of the notification message may be presented, among other example features and implementations.

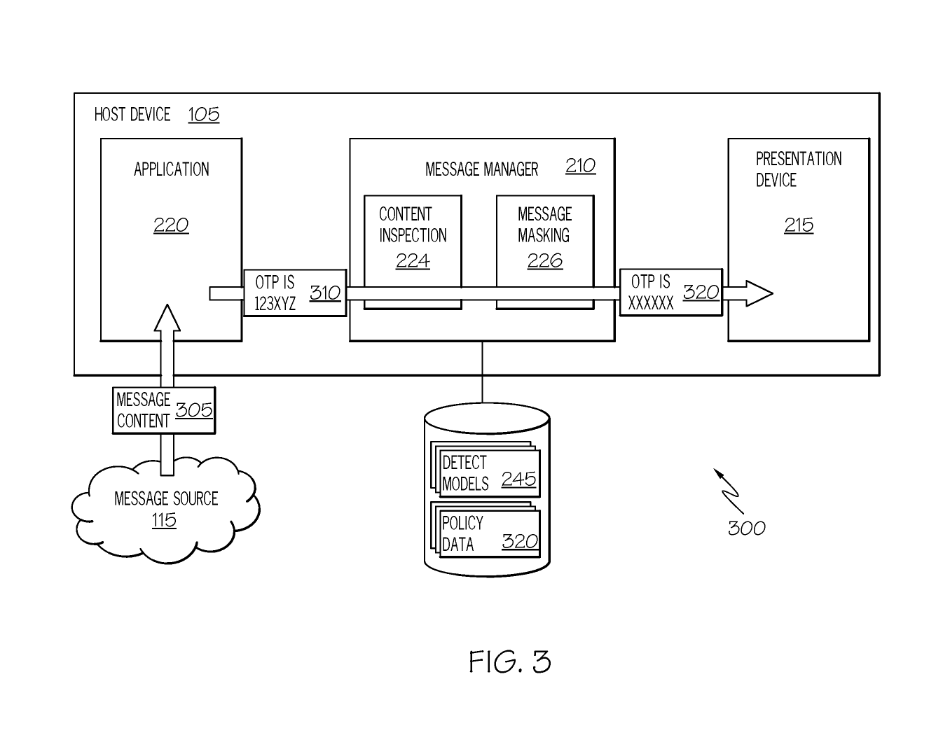

Turning to the example of FIG. 3, a simplified block diagram 300 is shown illustrating the example masking of a notification message by an example message manager 210 provided on a device. The message manager 210 may be implemented within the operating system of the device 105, as a separate application (e.g., a launcher application, which launches at startup of the device prior to the launch of any other applications, which may potentially generate notification messages), or as other logic implemented on the device 105. In this particular example, a source 115 of information to be included in content 305 of an example notification message 310 may be transmitted over a network to the device. The data from the message source 115 may be received by an application 220 equipped with functionality to generate a notification message 310, which includes some of the information provided from the message source 115. In this example, the notification message 310 may be provided to communicate an one-time password (OTP) (e.g., “123XYZ”) to a user. For instance, the OTP may be communicated in connection with the authentication of a financial transaction, reset of a password, to grant access to a secured domain, among other examples. Prior to the notification message 310 being presented on the host device 105 (e.g., graphically using a presentation device 215, such as a display), the message manager 210 may inspect content of the notification message 310 (e.g., using content inspection module 224) to identify that the notification message 310 includes sensitive information (e.g., the value of the OTP “123XYZ”). The message manager 210 may access detection models 240 and/or policy data 320 describing one or more policies or preferences to be used by the message manager 210 in the detection and masking of sensitive information in notification messages generated by the application 220. For instance, the message masking engine 226 may consult policy data 320 to determine a preferred way of masking information identified by the content inspection module 224 to be sensitive. Accordingly, the masking engine 226 may mask the sensitive information detected in the notification message 310 to generate a masked version 320 of the notification message 310, masking the OTP value “123XYZ” such that the value “XXXXXX” is instead displayed on display 215.

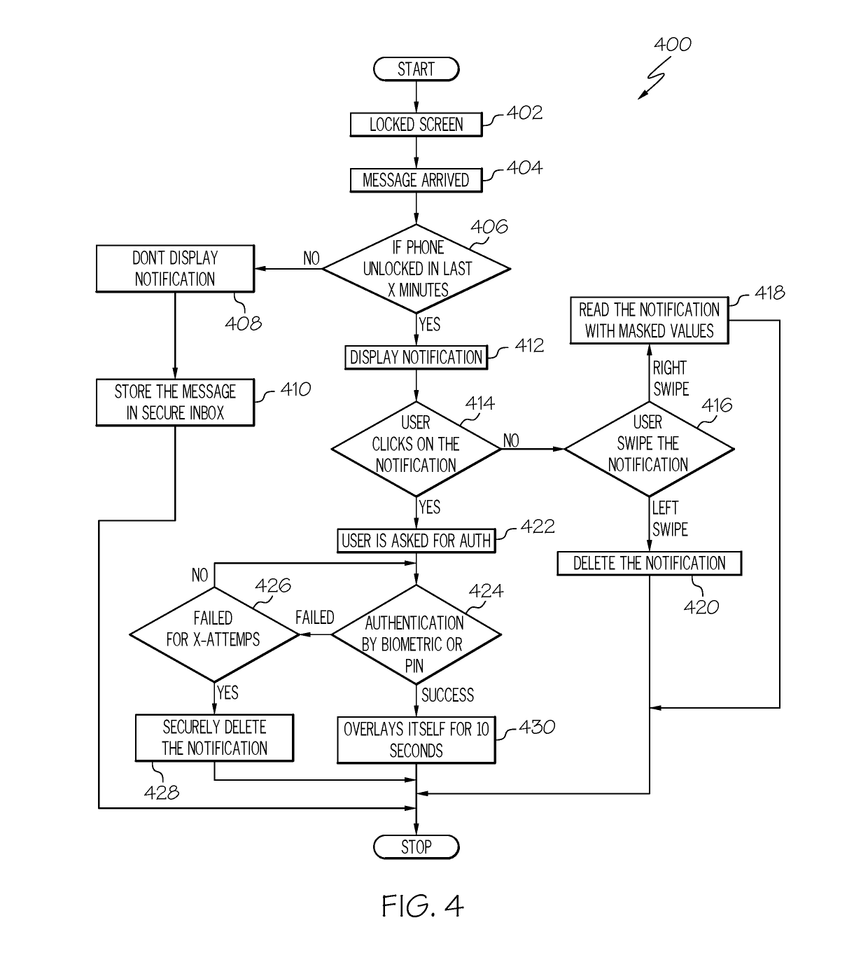

Turning to FIG. 4, a simplified flowchart 400 is shown illustrating techniques of an example message manager implemented on a user computing device. In one example, the user computer device may be detected to be in a locked state (e.g., 402). While in this state, the message manager may detect the arrival of a notification message 404 generated by a program on the device (e.g., using data received from another system over a network) and determine that the message include sensitive information. The message manager may further determine an amount of time between the last successful login at the device and the arrival of the message. A threshold amount of time may be defined (e.g., according to one or more policies applied to the device) and the message manager may determine (at 406) whether or not the time since the last successful login exceeds the defined threshold time. In this example, if the device (e.g., a smartphone) has not been unlocked or otherwise authenticated to within the threshold duration, the message manager may determine (at 408) that the notification message should not be displayed, due to an enhanced security risk associated with the longer time between logins. The notification message may instead be stored 410 within a secure inbox. If the device has been authenticated to within the defined threshold, a notification (e.g., which does not reveal any portion of the content of the message) may be displayed 412.

In one example, a graphical notification may be displayed 412 on a user display (e.g., a touchscreen) of the device. The notification may be interactive, allowing a user, through particular interactions to indicate whether the notification should be expanded to present more information, dismissed, saved, etc. For instance, in one example, the notice may be either clicked or swiped on a touchscreen upon presentation to a user. In this example, if the user, instead of clicking on the notice (e.g., 414), swipes the notice (at 416), the type of swipe may be detected. For instance, a right swipe may indicate a request to read an expanded version of the notification (at 418), which may include a masked version of the notification message. If the user instead swipe left, this may be interpreted, in this example, as a request to delete the notification (at 420), among other example actions and user interactions. For instance, if the user instead clicks on the notice (at 414), this may be interpreted as a request to access an unmasked version of the notification message corresponding to the displayed notice. For instance, upon clicking 414 the notice, the user may be prompted (at 422) for authentication information, such as a PIN, password, fingerprint, voice sample, other biometric, etc. The device (e.g., using authentication logic provided with the operating system of the device) may determine (at 424) whether to authenticate the present user based on the authentication information entered by the user. If the authentication attempt fails, if the number of failed attempts does not exceed a threshold (e.g., at 426), the user may be re-prompted to enter the authentication information. If a number of failed authentication attempts have been detected (at 426), the notification may be deleted 428 (e.g., based on a presumption that multiple failed authentication attempts in connection with the display of the notification correspond to an attempt by an unauthorized user to brute force their way to access the underlying notification message). On the other hand, if the user is authenticated (at 424) based on the provided authentication information, an unmasked version of the notification message may be presented to the user (e.g., 430). In one example, if a notification message has been determined to contain sensitive information, rather than displaying the message persistently in response to the user authentication, to further safeguard the sensitive content, the message manager may cause the unmasked version of the notification message to be displayed in the clear for a limited duration of time (e.g., 10 seconds), before causing the sensitive information to be re-masked or causing the unmasked version of the notification message to disappear. In some instances, a user may be required to reauthenticate before allowing the unmasked version of the notification message to be redisplayed. Further, successful authentication of the user may allow a user to further authenticate to a secure inbox to allow the user to view previously intercepted notification messages stored in the inbox (e.g., at 410) and determined to contain sensitive information, among other example implementations and features.

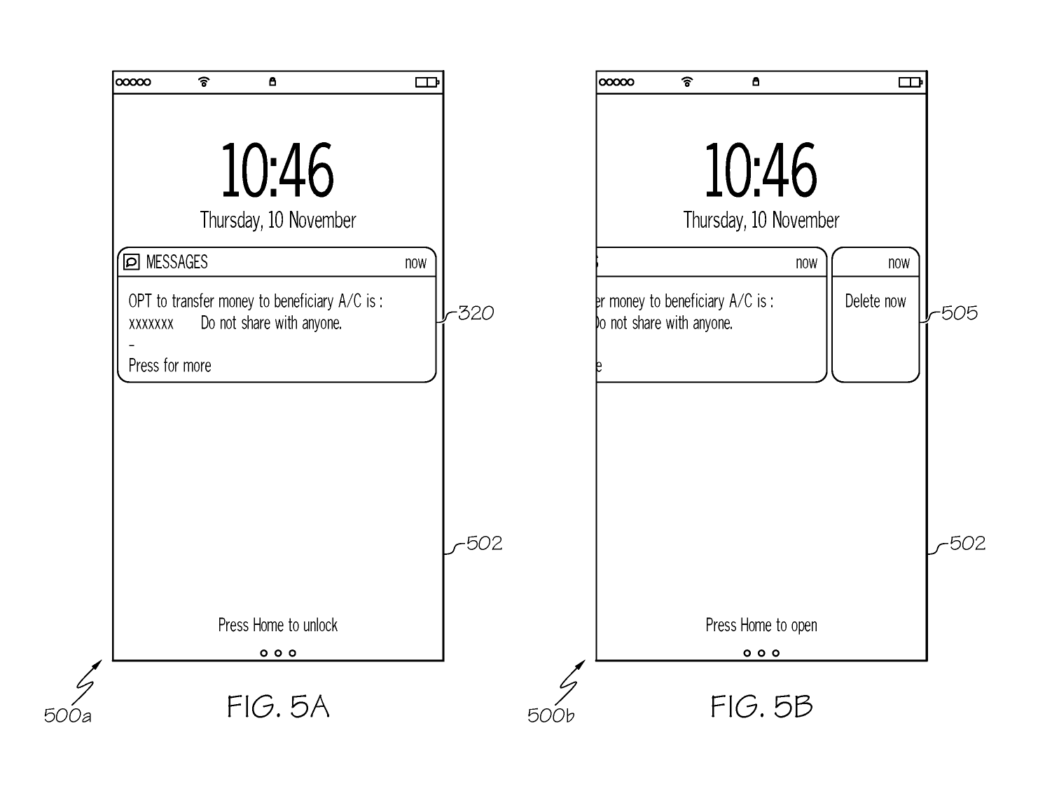

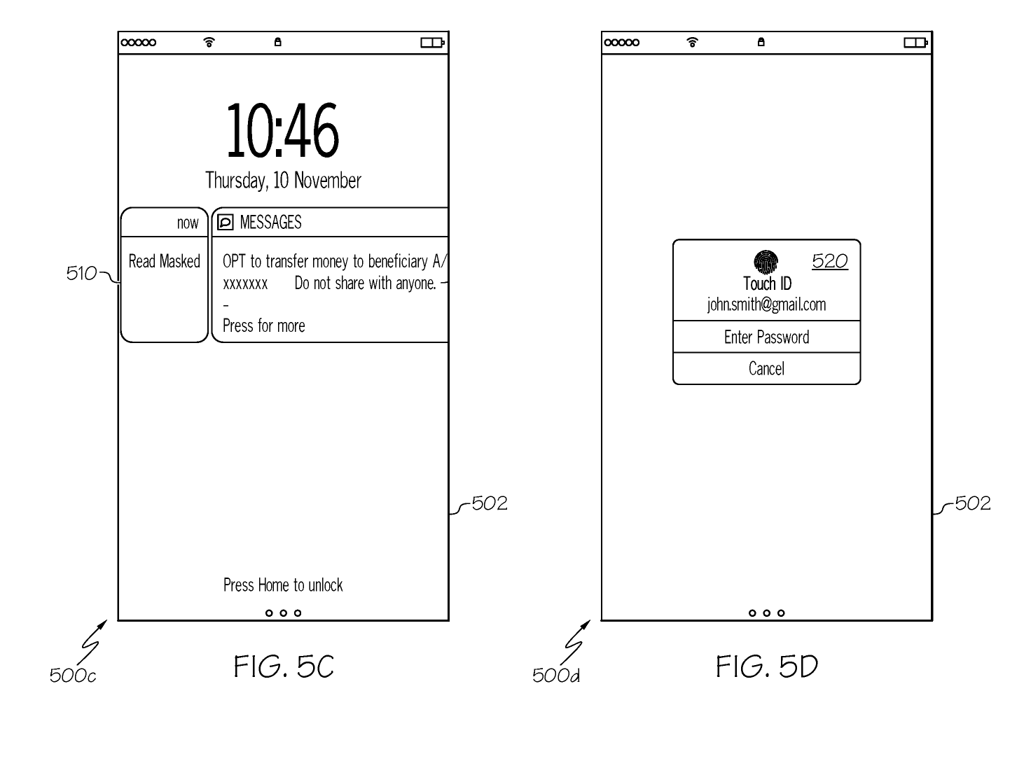

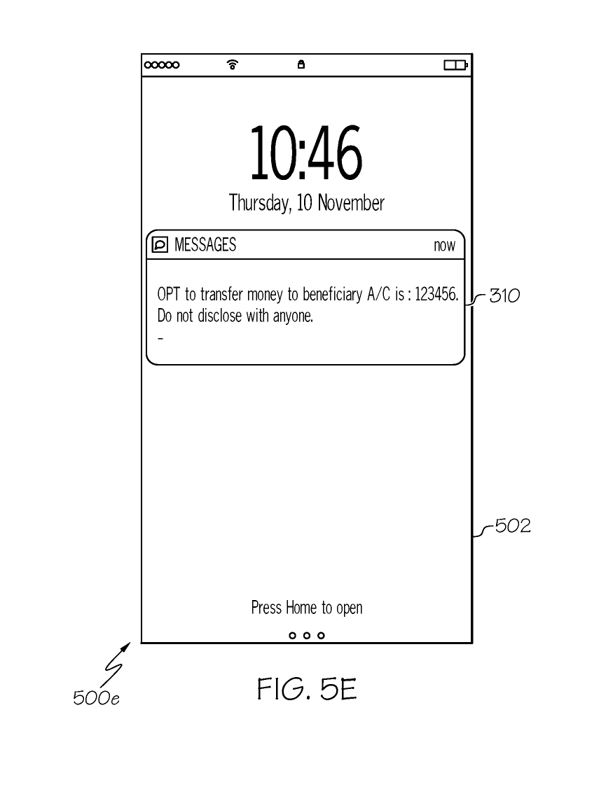

Turning to the examples of FIGS. 5A-5E illustrate screenshots (e.g., 500a-e) of an example graphical user interface to be displayed on a touchscreen 502 of an example user computing device equipped with an example message manager. For instance, in the example of FIG. 5A, a screenshot 500a is shown illustrating an example where a message manager has detected a notification message containing sensitive information and generated a masked version 320 of the notification message to obscure or hide the sensitive information detected in the message. For instance, in this example, an OTP is included in the notification message, the value of the OTP masked with asterisk characters replacing the actual OTP value in the masked version 320 of the notification message. In one example, a user may interact with the displayed masked notification message 320 to indicate how the user wishes to act upon the message. For instance, as shown in the example of FIG. 5B, a user may swipe left on the displayed masked notification message to cause an additional user interface element 505 to be presented, which when selected may cause the corresponding notification message (e.g., the unmasked version of the notification message) to be deleted (e.g., without ever displaying the message on the user interface 502). In another example, shown in FIG. 5C, swiping right on the displayed masked notification message 320 may cause an alternate user interface element 510 to be displayed to allow the user to request presentation of the unmasked version of the notification message. For instance, upon selecting the interface element 510, a user authentication prompt 515 may be presented on the user interface, such as illustrated in FIG. 5D. For instance, the user may be prompted to enter a PIN, provide a fingerprint sample, or provide other authentication information. If the user is able to provide legitimate authentication information, the user may be authenticated to the device. The message manager may identify the successful authentication of the user and, in response, present an unmasked version of the notification message (e.g., further in response to the selection of interface element 510) to the user on the user interface (e.g., as shown in the example of FIG. 5E). In some instances, the authentication may only authenticate the user to allow presentation of the unmasked notification message, without unlocking the device. In other cases, the authentication may both unlock the device and enable presentation of the unmasked notification message, among other example implementations.

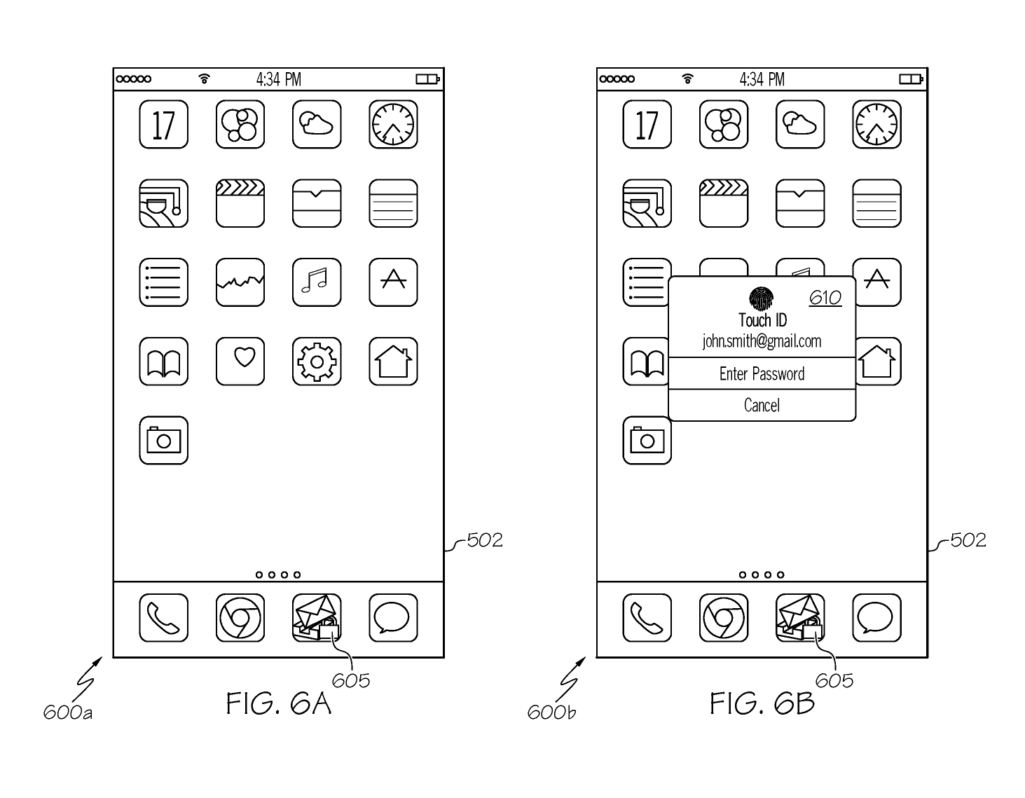

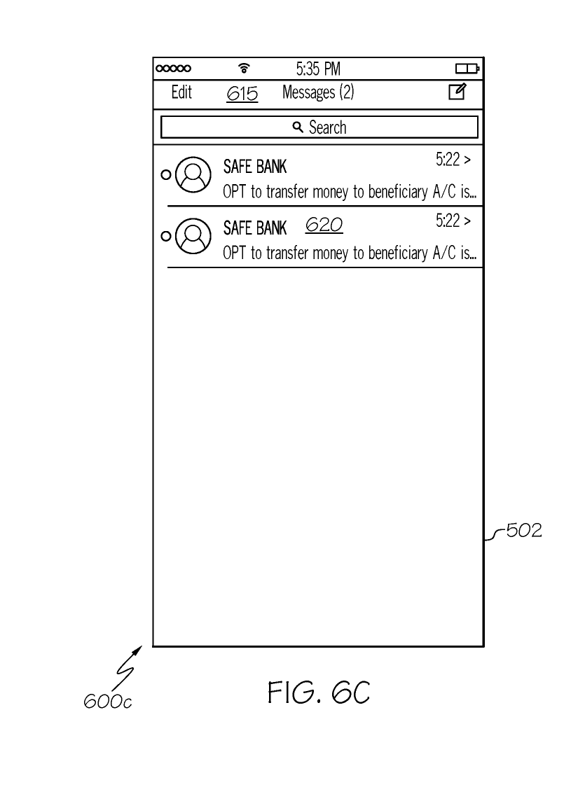

Turning to the examples of FIGS. 6A-6C, additional screenshots 600a-c are shown of an example user interface 502. In these examples, user interfaces are shown to illustrate the example access of a secure inbox used to store unmasked versions of notification messages detected to include sensitive information. For instance, in FIG. 6A, in response to authentication of a user, the user may access an interface with icon. By unlocking and authenticating to the device, the user may, among other programs, select to open a program managing access to a secure inbox used to secure notification messages containing sensitive information (e.g., using Secure Inbox icon 605). In one example, as shown in FIG. 6B, a user selection of the icon 605 may request access to the secure inbox, causing a prompt 610 to be presented requiring authentication information from the user before the user is allowed to proceed to the messages stored in the secure inbox (which may be hosted on the device itself and/or on a remote system). The authentication information may be the same or similar to the authentication information used to unlock the device, or alternatively, may be entirely distinct and different authentication information specific to authenticating to the secure inbox. As shown in the example of FIG. 6C, through successful authentication of the user to the secure inbox, an inbox view 615 may be presented, displaying a listing of secured notification messages, which a message manager has detected as including sensitive information. The user may then select a particular one of the notification messages (e.g., 620) in the listing to allow the user to view an unmasked version of the particular notification message, among other example implementations.

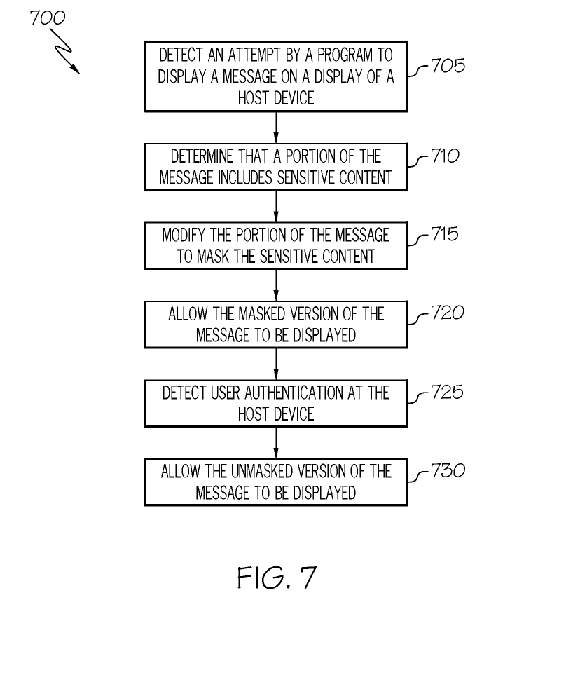

FIG. 7 is a flowchart 700 showing an example technique for securing messages for presentation on a user computing device. For instance, an attempt by a program hosted on a user computing device (or host device), such as a smartphone, smartwatch or other wearable device, or other personal computing device, may be detected 705 to present a message on the device, such as by emitting an audio message or displaying the message on a display of the device. The attempted message may be detected by a message manager utility implemented in hardware and/or software on the host device. A portion of the message may be determined 710 by the message manager to include sensitive content, or content including or representing sensitive information. The portion of the message may be modified 715 by the message manager to mask the sensitive content before allowing 720 the message to be presented (e.g., displayed) on the host device. In other instances, the message manager may instead save the message in a secure inbox in response to detecting a higher risk that the device is not in the possession of an authorized user (e.g., when a period of time has passed since the last successful login, when the device (e.g., through an accelerometer or gyroscope on the device) is sensed to likely not be carried by the user, among other conditions), among other example features and flows. In this example, the message manager may detect 725 a successful user authentication at the host device and, in response, may allow 730 an unmasked version of the message to be displayed to the user (as well as allow a user to access unmasked messages stored in a secure inbox), among other examples.

It should be appreciated that the flowcharts and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method comprising:
receiving a user input at a handheld computing device to indicate that a masked version of a first message presented on a graphical display of the computing device masked non-sensitive information included in an original version of the first message, wherein masking portions of messages on the computing device is based on a model;
updating the model, using at least one data processing apparatus, based on the user input;
detecting, at the computing device, using at least one data processing apparatus of the computing device, an attempt by a particular program on the computing device to present a particular message on the graphical display of the computing device;
autonomously determining, using at least one data processing apparatus, prior to presentation of the particular message on the graphical display, that at least a portion of content of the particular message comprises sensitive information based on the updated model;
determining that another portion of the content may be presented in the clear based on the updated model;
modifying, using at least one data processing apparatus, the content of the particular message to generate a masked version of the particular message based on the updated model, wherein the masked version masks the portion of the content; and
presenting the masked version of the particular message on the graphical display in lieu of an unmasked version of the particular message based on determining that the particular message comprises the sensitive information, wherein the other portion of the content is to be presented in the clear in the masked version of the particular message.

2. (canceled)

3. (canceled)

4. The method of claim 1, comprising receiving, through the computing device, the user supervision data.

5. The method of claim 4, wherein the model is further based on user supervision data corresponding to messages received on other computing devices.

6. The method of claim 1, wherein the particular message comprises a message to be displayed when the computing device in an unauthenticated state.

7. The method of claim 6, wherein the unauthenticated state comprises a locked state in which user access to the computing device is locked.

8. The method of claim 1, further comprising:
receiving a user input to request presentation of the masked portion of the particular message;
presenting a user authentication prompt in response to the user input;
receiving authentication data in response to the user authentication prompt;
authenticating the user based on the authentication data; and
presenting the particular message with the portion of the content unmasked based on authentication of the user.

9. The method of claim 1, wherein the particular message comprises a short message service (SMS) message and the particular program comprises an SMS message handler.

10. The method of claim 1, wherein the particular message comprises an internet protocol (IP)-based message generated from data received over an IP connection at the computing device from another system.

11. The method of claim 1, further comprising:
determining a time duration between a last successful login at the computing device and the attempt to present the particular message; and
determining that the time duration is less than a threshold duration, wherein the masked version of the particular message is allowed to be presented based at least in part on the time duration being less than the threshold duration.

12. The method of claim 1, wherein determining that a time duration between a last successful login and an attempt to present a message is greater than the threshold causes the corresponding message to be blocked from presentation.

13. The method of claim 12, wherein determining that a time duration between a last successful login and an attempt to present a message is greater than the threshold causes the corresponding message to be stored in a secured inbox, wherein access to the secured inbox requires user authentication.

14. The method of claim 1, wherein the sensitive information comprises a one-time password.

15. A non-transitory computer readable medium having program instructions stored therein, wherein the program instructions are executable by a computer system to perform operations comprising:
receiving a user input at a handheld computing device to indicate that a masked version of a first message presented on a graphical display of the computing device masked non-sensitive information included in an original version of the first message, wherein masking portions of messages on the computing device is based on a model;
updating the model, using at least one data processing apparatus, based on the user input;
detecting a second message generated by a particular program on the handheld computing device for presentation on the graphical display of the computing device;
autonomously determining, prior to display of the second message, that a first portion of the second message comprises sensitive information based on the model;
determining that another portion of the content may be presented in the clear based on the updated model;
modifying the second message to generate a masked version of the second message based on the updated model, wherein the masked version presents a second portion of the second message and masks the first portion of the second message; and
causing the masked version of the second message to displayed on the graphical display instead of the second message as generated by the particular program based on determining that the second message comprises the sensitive information, wherein the other portion of the content is to be presented in the clear in the masked version of the second message.

16. A mobile computing device comprising:
a data processing apparatus;
a memory element to store a model;
a graphical display;
a plurality of applications, wherein a subset of the plurality of applications are to generate messages for display on the graphical display when the mobile computing device is in a locked state; and
a message manager, executable by the data processing apparatus, to:
receive a user input to indicate that a masked version of a first message presented on the graphical display masked non-sensitive information included in an original version of the first message, wherein masking portions of messages on the mobile computing device is based on the model;
update the model based on the user input;
detect a second message, generated by a particular one of the subset of application, to be displayed on the graphical display while the mobile computing device is in a locked state;
autonomously determine, prior to display of the second message, that a portion of the second message comprises sensitive information based on a model;
determine that another portion of the content may be presented in the clear based on the model, wherein the model is derived based on a collection of user feedback indicating that previous determinations that messages did or did not comprise sensitive information were under- or over-inclusive;
modify the second message to generate a masked version of the second message, wherein the masked version masks the portion of the second message; and
cause the masked version of the second message to be displayed on the graphical display based on determining that the second message comprises the sensitive information, wherein the other portion of the content is to be presented in the clear in the masked version of the second message.

17. The mobile computing device of claim 16, further comprising an operating system, wherein the operating system comprises the message manager.

18. The mobile computing device of claim 16, wherein the message manager comprises a message manager application to be launched on the mobile computing device prior to at least the subset of the plurality of applications.

19. The mobile computing device of claim 16, further comprising a learning module, executable by the data processing apparatus, to determine the model from user inputs received corresponding to a plurality of other messages at the mobile computing device, wherein the user feedback comprises the user inputs.

20. The mobile computing device of claim 16, wherein the subset of applications comprises two or more applications, and the message manager is to inspect messages from each of the subset of applications to generate masked versions of messages from any one of the subset of applications to mask sensitive information included in the corresponding message.
